(19) United States
(12) Patent Application Publication
(10) Pub. No.: US 2019/0378016 A1
(43) Pub. Date: Dec. 12, 2019

(54) DISTRIBUTED COMPUTING ARCHITECTURE FOR LARGE MODEL DEEP LEARNING

(71) Applicant: International Business Machines Corporation, Armonk, NY (US)

(72) Inventors: Anto A. R. John, Bangalore (IN); Saritha Vinod, Bangalore (IN)

(21) Appl. No.: 16/002,636

(22) Filed: Jun. 7, 2018

(51) Int. Cl. G06N 3/08; G06N 3/063; G06N 3/04; H04L 29/08

(52) U.S. Cl. CPC G06N 3/084; H04L 67/10; G06N 3/04; G06N 3/063

(57) ABSTRACT

A distributed network architecture for deep learning including a model mapping table (MMT) storing information regarding respective portions of a deep learning model distributed amongst a plurality of interconnected host nodes. Respective host nodes can comprise at least one central processing unit (CPU), at least one CPU memory, at least one graphics processing unit (GPU), and at least one GPU memory. The deep learning model can be trained by receiving a request from a requesting GPU for a first portion of the deep learning model, identifying a first host node storing the first portion of the deep learning model, providing a first copy of the first portion of the deep learning model to the requesting GPU memory, performing processing on the first copy by the requesting GPU, and updating the MMT based on the processing performed on the first copy of the first portion of the deep learning model.

### BACKGROUND

The present disclosure relates to a distributed computing architecture, and, more specifically, to a distributed computing architecture for training large deep learning models.

### SUMMARY

Aspects of the present disclosure are directed toward a computer-implemented method comprising generating a model mapping table (MMT) storing information regarding respective portions of a deep learning model distributed amongst a plurality of interconnected host nodes. Respective host nodes can comprise at least one central processing unit (CPU), at least one CPU memory, at least one graphics processing unit (GPU), and at least one GPU memory. The deep learning model can comprise an amount of data larger than an amount of memory in any respective host node of the plurality of interconnected host nodes. The method can further comprise training the deep learning model by training the respective portions of the deep learning model on the plurality of interconnected host nodes. The training can comprise receiving a request from a requesting GPU for a first portion of the deep learning model, where the requesting GPU is associated with a requesting GPU memory and a requesting host node. The training can further comprise identifying a first host node of the plurality of interconnected host nodes storing the first portion of the deep learning model based on information in the MMT and transferring the first portion of the deep learning model from the first host node to the requesting host node. The training can further comprise providing a first copy of the first portion of the deep learning model from the requesting host node to the requesting GPU memory and performing processing, by the requesting GPU, on the first copy of the first portion of the deep learning model stored in the requesting GPU memory. The training can further comprise synchronizing the first copy of the first portion of the deep learning model with the first portion of the deep learning model in response to performing processing, and updating the MMT based on synchronizing the first copy of the first portion of the deep learning model.

Aspects of the present disclosure are directed toward a system comprising a processor and a computer-readable storage medium storing program instructions for deep learning model training which, when executed by the processor, are configured to cause the processor to perform a method comprising generating a model mapping table (MMT) storing information regarding respective portions of a deep learning model distributed amongst a plurality of interconnected host nodes. Respective host nodes can comprise at least one central processing unit (CPU), at least one CPU memory, at least one graphics processing unit (GPU), and at least one GPU memory. The deep learning model can comprise an amount of data larger than an amount of memory in any respective host node of the plurality of interconnected host nodes. The method can further comprise training the deep learning model by training the respective portions of the deep learning model on the plurality of interconnected host nodes. The training can comprise receiving a request from a requesting GPU for a first portion of the deep learning model, where the requesting GPU is associated with a requesting GPU memory and a requesting host node. The training can further comprise identifying a first host node of the plurality of interconnected host nodes storing the first portion of the deep learning model based on information in the MMT and transferring the first portion of the deep learning model from the first host node to the requesting host node. The training can further comprise providing a first copy of the first portion of the deep learning model from the requesting host node to the requesting GPU memory and performing processing, by the requesting GPU, on the first copy of the first portion of the deep learning model stored in the requesting GPU memory. The training can further comprise synchronizing the first copy of the first portion of the deep learning model with the first portion of the deep learning model in response to performing processing, and updating the MMT based on synchronizing the first copy of the first portion of the deep learning model.

Aspects of the present disclosure are directed toward a computer program product comprising a computer readable storage medium, where the computer readable storage medium stores instructions executable by a processor to cause the processor to perform a method comprising generating a model mapping table (MMT) storing information regarding respective portions of a deep learning model distributed amongst a plurality of interconnected host nodes. Respective host nodes can comprise at least one central processing unit (CPU), at least one CPU memory, at least one graphics processing unit (GPU), and at least one GPU memory. The deep learning model can comprise an amount of data larger than an amount of memory in any respective host node of the plurality of interconnected host nodes. The method can further comprise training the deep learning model by training the respective portions of the deep learning model on the plurality of interconnected host nodes. Training respective portions of the deep learning model can comprise transferring, using a message passing interface (MPI) remote memory access (RMA) protocol, respective portions of the deep learning model between respective host nodes of the plurality of interconnected host nodes and providing respective copies of the respective portions of the deep learning model to respective GPU memories for processing.

The above summary is not intended to illustrate each embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example distributed network architecture for large model deep learning, in accordance with some embodiments of the present disclosure.

FIG. 2 illustrates a flowchart of an example method for initializing a network architecture for deep learning, in accordance with some embodiments of the present disclosure.

FIG. 3 illustrates a flowchart of an example method for training a deep learning model on a network architecture, in accordance with some embodiments of the present disclosure.

FIG. 4 illustrates a flowchart of an example method for utilizing a deep learning model, in accordance with some embodiments of the present disclosure.

FIG. 5 illustrates a block diagram of an example large model manager (LMM), in accordance with some embodiments of the present disclosure.

FIG. 6 depicts a cloud computing environment according to some embodiments of the present disclosure.

FIG. 7 depicts abstraction model layers according to some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward a distributed computing architecture, and, more specifically, to a distributed computing architecture for training large deep learning models. While the present disclosure is not necessarily limited to such applications, some aspects of the disclosure can be appreciated through a discussion of various examples using this context.

Deep learning has applications in technological fields such as, but not limited to, healthcare, space research, computer vision, speech recognition, natural language processing, machine translation, bioinformatics, drug design, polymer synthesis, social networking, complex system monitoring, medical imaging, cybersecurity, and other technological fields. Deep learning can be used to identify, classify, and/or predict complex interrelationships associated with large amounts of input data.

Deep learning models can comprise models associated with an input layer, an output layer, and one or more hidden layers. Deep learning models can comprise, but are not limited to, artificial neural networks (ANNs), deep neural networks (DNNs), convolutional neural networks (CNNs), deep belief systems, recurrent neural networks, hierarchical temporal memory, and/or other networks inspired by neurological learning processes.

Deep learning models can be trained (e.g., supervised training, semi-supervised training, or unsupervised training) using forward propagation and/or backpropagation. Forward propagation can comprise generating output data based on input data in each layer and providing the generated output as input to a sequential layer until a final output is generated. Deep learning models can use any number of layers. The final output can be compared to real values to generate error results. Backpropagation can be used to reduce the error by determining a derivative of error for each weight in each layer of the deep learning model and modifying weight values based on the determined derivative of error (e.g., by subtracting the determined derivative from the weight). Training a deep learning model can involve any number of forward propagation and/or backpropagation steps until an acceptable error value is achieved (e.g., an error rate below a threshold).

Deep learning model training can be performed using central processing units (CPUs) and/or graphics processing units (GPUs). CPUs can perform a wider variety of tasks and can be associated with a larger memory component compared to GPUs. GPUs can perform some tasks significantly faster than CPUs, but GPUs can also be associated with smaller memory components than CPUs.

One solution involves training large deep learning models using CPUs rather than GPUs because CPU memories are larger than GPU memories. However, the training time using a CPU is significantly greater than the training time using a GPU. Furthermore, the deep learning model is still limited in size to the CPU memory size.

Another solution involves storing the deep learning model in the CPU memory and transferring portions of the model to a GPU on a same node for processing as needed. However, the deep learning model is still limited in size to the CPU memory.

In order to overcome the speed and memory limitations described above, training a deep learning model can be performed on a distributed network architecture. The deep learning model can be distributed using data parallelism or model parallelism. Data parallelism can separate input data across separate CPUs and/or GPUs. Model parallelism can separate portions of the deep learning model (e.g., portions of layers, individual layers, combinations of layers, parameters, gradients, etc.) across separate CPUs and/or GPUs. Aspects of the present disclosure are directed toward improved distributed training of a deep learning model using model parallelism or data parallelism. Some embodiments of the present disclosure are especially suited to improved model parallelism.

In some embodiments of the present disclosure, a large model manager (LMM) manages an interconnected cluster of host nodes using a large model pooler (LMP) and a model mapping table (MMT) to transparently train a large deep learning model using model parallelism. Each host node can have at least one CPU, at least one CPU memory, at least one GPU, and/or at least one GPU memory. The MMT can track respective portions of the deep learning model distributed amongst the interconnected cluster of host nodes using a plurality of records in the MMT. Each record in the MMT can comprise, for a portion of the deep learning model, a pointer, a layer identification, a rank of a process requesting the portion of the deep learning model, a memory handle and memory offset associated with the host node storing the requested portion of the deep learning model, metadata (e.g., data type), and/or flags (e.g., a reuse data function, a recompute function, etc.). The LMM can manage the deep learning model distribution using the LMP and the MMT. The LMP can allocate portions of the deep learning model (e.g., layer, gradients, parameters, datasets, etc.) from a CPU memory on one host node to an available GPU memory on the same or a different host node for processing. Such allocations can be based on information in the MMT. The MMT can be updated once any allocation is made. In some embodiments, allocations can be made using a message passing interface (MPI) based Remote Memory Access (RMA) technique.

Aspects of the present disclosure provide numerous advantages that improve deep learning model training by increasing the acceptable size of deep learning models and/or by decreasing an amount of time required to train deep learning models.

First, aspects of the present disclosure can scale to very large deep learning models (e.g., deep learning models that do not fit in any single CPU memory, GPU memory, or host memory). This improvement can be realized by the LMM, LMP, and MMT which transparently manage the distribution of the deep learning model across a cluster of interconnected host nodes. Thus, aspects of the present disclosure can accommodate deep learning models distributed across several, tens, or even hundreds of host nodes. Thus, the amount of data used by the deep learning model can exceed an amount of memory available on any of the host nodes.

Second, aspects of the present disclosure increase the speed of deep learning model training. This improvement can be realized by MPI RMA communications between host nodes and by performing processing using GPUs. MPI RMA communications between host nodes can accelerate transferring relevant portions of the deep learning model to appropriate host nodes by reducing the amount of interaction required between host nodes. Processing respective portions of the model using GPUs can accelerate the rate of training compared to using CPUs.

Third, aspects of the present disclosure can further increase the size of a deep learning model and the speed of training the deep learning model by providing customizable granularity to the size and content of various portions of the deep learning model. For example, aspects of the present disclosure can distribute an individual operation (e.g., processing on a portion of a single layer) across multiple GPUs where the individual operation uses a larger amount of data than can fit in any single memory of any single GPU. Thus, even in situations where a single layer of the deep learning model does not fit in any single CPU or GPU memory, aspects of the present disclosure can nonetheless process portions of the single layer across multiple GPUs.

The aforementioned advantages are example advantages, and embodiments exist that can contain all, some, or none of the aforementioned advantages while remaining within the spirit and scope of the present disclosure.

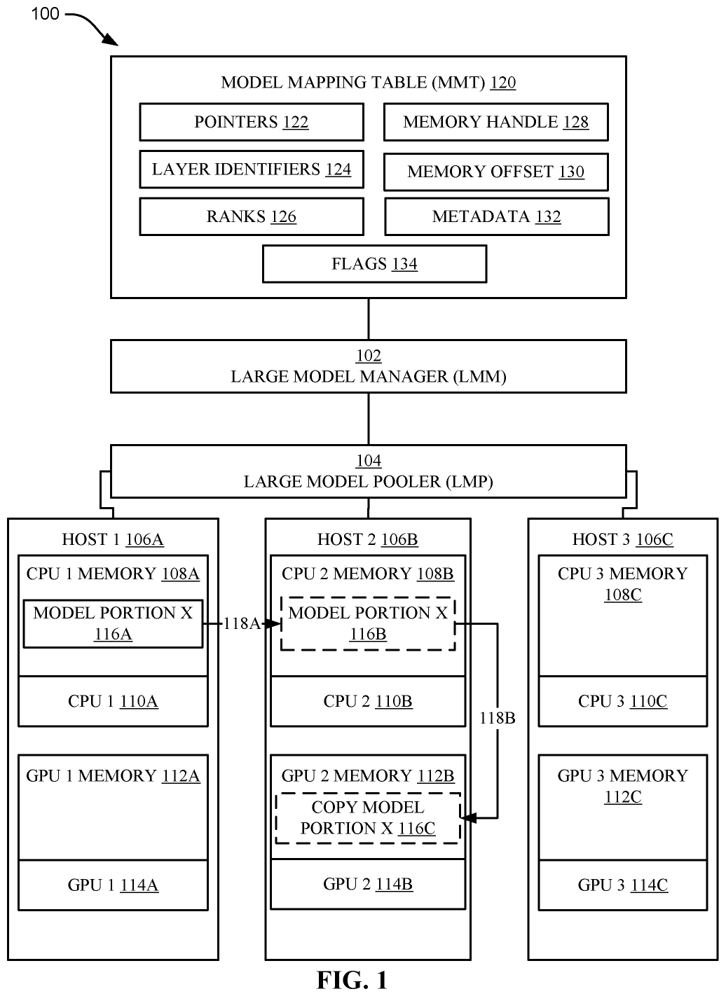

Referring now to the figures, FIG. 1 illustrates an example network architecture 100 for distributed training of a deep learning model, in accordance with some embodiments of the present disclosure. Network architecture 100 can comprise a large model manager (LMM) 102 communicatively coupled to a large model pooler (LMP) 104 and a model mapping table (MMT) 120. The LMM 102 can manage training the deep learning model based on information stored in MMT 120 and allocations made to hosts 106, CPU memories 108, CPUs 110, GPU memories 112, and/or GPUs 114 by the LMP 104.

LMP 104 can comprise pooling functionality capable of organizing and deploying a set of computational resources. LMP 104 is communicatively coupled to a plurality of hosts 106 (e.g., host 1 106A, host 2 106B, and host 3 106C). Each host 106 comprises at least one CPU memory 108 (e.g., CPU 1 memory 108A, CPU 2 memory 108B, and CPU 3 memory 108C), at least one CPU 110 (e.g., CPU 1 110A, CPU 2 110B, and CPU 3 110C), at least one GPU memory 112 (e.g., GPU 1 memory 112A, GPU 2 memory 112B, and GPU 3 memory 112C), and at least one GPU 114 (e.g., GPU 1 114A, GPU 2 114B, and GPU 3 114C).

Although three hosts 106 are shown, any number of hosts 106 are possible (e.g., tens, hundreds, thousands). Although LMM 102, LMP 104, and MMT 120 are shown separately, in some embodiments, LMM 102 stores MMT 120 and contains functionality equivalent to LMP 104. In some embodiments, hosts 106 are communicatively coupled with LMM 102, LMP 104, and/or MMT 120 by a physical network (e.g., Ethernet, InfiniBand), a virtual network, or a combination of the aforementioned. In some embodiments, hosts 106 comprise physical resources. In some embodiments, hosts 106 comprise virtual resources provisioned in a cloud computing environment. In some embodiments, hosts 106 comprise bare metal resources provisioned in a cloud computing environment.

CPU memories 108 can be, but are not limited to, main memory, internal memory, random-access memory (RAM), processor registers, processor caches, hard disk drives, optical storage devices, flash memories, non-volatile memories, dynamic random-access memories, and/or virtual memories.

CPUs 110 can be, but are not limited to, transistor CPUs, small-scale integration CPUs, large-scale integration CPUs (LSIs), microprocessors, and/or other configurations of integrated circuits useful for storing, reading, and/or executing computer-related tasks.

GPU memories 112 can be memory configured to function with a GPU 114. In some embodiments, GPU memories 112 exhibit lower clock rates and a wider memory bus (e.g., high bandwidth memories) relative to CPU memories 108. In some embodiments GPU memories 112 can comprise integrated graphics solutions that use CPU memories 108 (e.g., shared graphics, integrated graphics processors (IGPs), unified memory architectures (UMAs), hybrid graphics processing, etc.).

GPUs 114 can be specialized electronic circuits capable of processing data faster than CPUs 110. GPUs 114 can be, but are not limited to, dedicated graphics cards, integrated graphics, shared graphics solutions, integrated graphics processors (IGPs), unified memory architectures (UMAs) and/or other GPU configurations useful for storing, reading, and/or executing computer-related tasks.

CPU memories 108 can store respective portions of a deep learning model. For example, CPU 1 memory 108A can store a model portion X 116A. Although example model portion X 116A is shown in CPU 1 memory 108A, model portions X 116A could be in any memory associated with host 1 106A (e.g., external storage unit) and need not necessarily be in a CPU memory 108.

GPU memories 112 can store copies of portions of the deep learning model and can perform operations on the stored copies. For example, GPU 2 memory 112B can store a working copy of model portion X 116C. In some embodiments, GPU 2 114B requests model portion X 116A via LMP 104 and/or LMM 102 in order to perform processing (e.g., training) on model portion X 116A. In response to receiving the request from GPU 2 114B, LMP 104 and/or LMM 102 can identify host 1 106A as the host node storing model portion X 116A based on information in MMT 120. In response, model portion X 116A can be transferred 118A from CPU 1 memory 108A to CPU 2 memory 108B on host 2 106B using MPI RMA communication such that host 2 106B stores model portion X 116B. A working copy model portion X 116C can be generated and stored 118B in GPU 2 memory 112B for processing by GPU 2 114B. After processing, any updates to copy model portion X 116C can be synchronized with model portion X 116B, updated model portion X 116B can be transferred to an available host 106 for efficient storage, and the MMT 120 can updated.

Thus, aspects of the present disclosure advantageously allow portions of the deep learning model stored on a CPU memory 108 on a first host 106 to be transferred to a second GPU memory 112 on a different host 106 for processing by a GPU 114 associated with the different host 106. Transferring portions of the deep learning model between hosts 106 allows the LMM 102 and/or LMP 104 to efficiently use all available resources in the network architecture 100, thereby increasing the allowable size of the deep learning model and decreasing the time required to train the deep learning model.

In some embodiments, transferring respective portions of the deep learning model between hosts 106 is performed using MPI RMA communications between and/or within hosts 106. MPI RMA communications can accelerate transfer of the model portions between hosts 106 (e.g., because both hosts do not need to be involved), thereby reducing the amount of time required to train a deep learning model in the network architecture 100.

In various embodiments, a model portion (e.g., model portion X 116A, 116B, and/or 116C) can comprise individual layers, error functions (e.g., gradients), parameters (e.g., variables, weights, biases, etc.), and/or datasets associated with a deep learning model. In some embodiments, a model portion can comprise a single layer of the deep learning model, a portion of a single layer of the deep learning model, data associated with an operation of the deep learning model, or data associated with a portion of an operation of the deep learning model.

In some embodiments, a model portion can comprise a portion of an operation where the data associated with the operation does not fit in any GPU memory 112 of the network architecture 100. Thus, aspects of the present disclosure can distribute portions of a single operation across multiple GPU memories 112 for processing by respective GPUs 114, thereby increasing the allowable size of deep learning models that can be trained in the distributed network architecture 100.

MMT 120 can be used to store information regarding model portions (e.g., model portion X 116A, 116B, and 116C), CPU memories 108, CPUs 110, GPU memories 112, GPUs 114, and/or hosts 106. MMT 120 can store pointers 122, layer identifiers 124, ranks 126, memory handles 128, memory offsets 130, metadata 132, and/or flags 134.

Pointers 122 can comprise pointers indicating a host 106, CPU memory 108, CPU 110, GPU memory 112, and/or GPU 114 associated with a respective portion of the deep learning model.

Layer identifiers 124 can comprise identification values (e.g., names, numeric identifiers, alphanumeric identifiers, etc.) for respective layers in the deep learning model (e.g., input layers, output layers, hidden layers, etc.). In some embodiments, layer identifiers 124 indicate a portion of a layer (e.g., a first portion of a third layer of the deep learning model).

Ranks 126 can comprise respective process ranks associated with a process to be implemented by a requesting GPU 114 for a portion of the deep learning model. Ranks 122 can be useful for ordering and prioritizing training in the network architecture 100 where tens or hundreds of GPUs may be requesting portions of the deep learning model within a same time interval. In some embodiments, ranks 126 are associated with respective instances of the MPI communication protocol.

Memory handles 128 can comprise a reference to a resource associated with a portion of the deep learning model. In some embodiments, memory handles 128 indicate a window of available memory configured for MPI RMA communication in a CPU memory 108, GPU memory 112, or a different memory associated with a host 106.

Memory offsets 130 can be used to indicate locations of portions of the deep learning model. Memory offsets 130 can indicate an offset relative to a window of accessible memory in any CPU memory 108, GPU memory 112, or other memory associated with a host 106.

Metadata 132 can comprise data types (e.g., parameter, gradient, temperature data, etc.) and/or data characteristics (e.g., times, origins, etc.).

Flags 134 can indicate functions associated with portions of the deep learning model, such as, but not limited to reuse data functions, recompute functions, and/or other functions.

For the purpose of illustrating aspects of the present disclosure, consider the following example. Model portion X 116A residing in CPU 1 memory 108A comprises a portion of a layer of a deep learning model (also referred to as a deep learning model object). Model portion X 116A is associated with a record in MMT 120 storing a pointer 122, memory handle 128, and memory offset 130 indicating the location of model portion X 116A in CPU 1 memory 108A. MMT 120 also stores a layer identifier 124 indicating the layer associated with model portion X 116A.

LMM 102 instructs LMP 104 to train the deep learning model, including model portion X 116A. LMP 104 identifies GPU 2 memory 112B as having sufficient space to store model portion X 116A and GPU 2 114B having sufficient processing capacity to perform training on model portion X 116A. LMP 104 uses MMT 120 to identify that model portion X 116A resides in CPU 1 memory 108A. LMP 104 uses an MPI RMA communication protocol to transfer 118A model portion X 116B into CPU 2 memory 108B and to then generate and store 118B copy model portion X 116C in GPU 2 memory 112B. LMP 104 updates MMT 120 with the copy model portion X 116C on GPU 2 memory 112B. GPU 2 114B performs processing on copy model portion X 116C. After processing, LMP 104 synchronizes processed copy model portion X 116C with model portion X 116B. LMP 104 updates MMT 120 with the updated information. In some embodiments, LMP 104 transfers the synchronized model portion X 116B to a different host 106 for efficient storage (and subsequently updates MMT 120).

The aforementioned example process can occur any number of times for any number of model portions of a deep learning model until the deep learning model is fully trained. Thus, as shown in the previous example, aspects of the present disclosure can transparently and efficiently train a very large deep learning model.

FIG. 1 is intended to represent the major components of an example network architecture 100 according to embodiments of the present disclosure. In some embodiments, however, individual components can have greater or lesser complexity than shown in FIG. 1, and components other than, or in addition to those shown in FIG. 1 can be present. Furthermore, in some embodiments, various components illustrated in FIG. 1 can have greater, lesser, or different functionality than shown in FIG. 1.

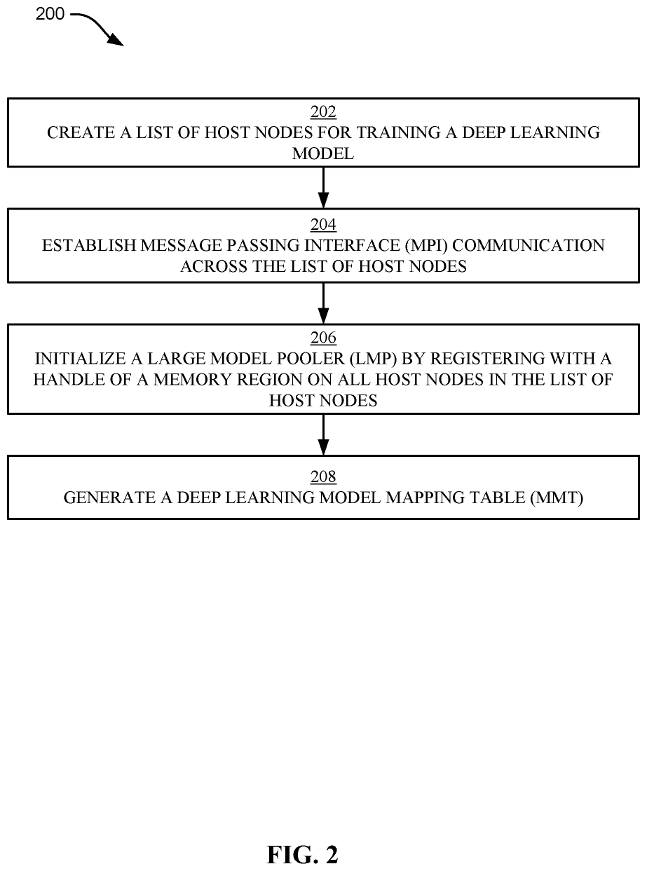

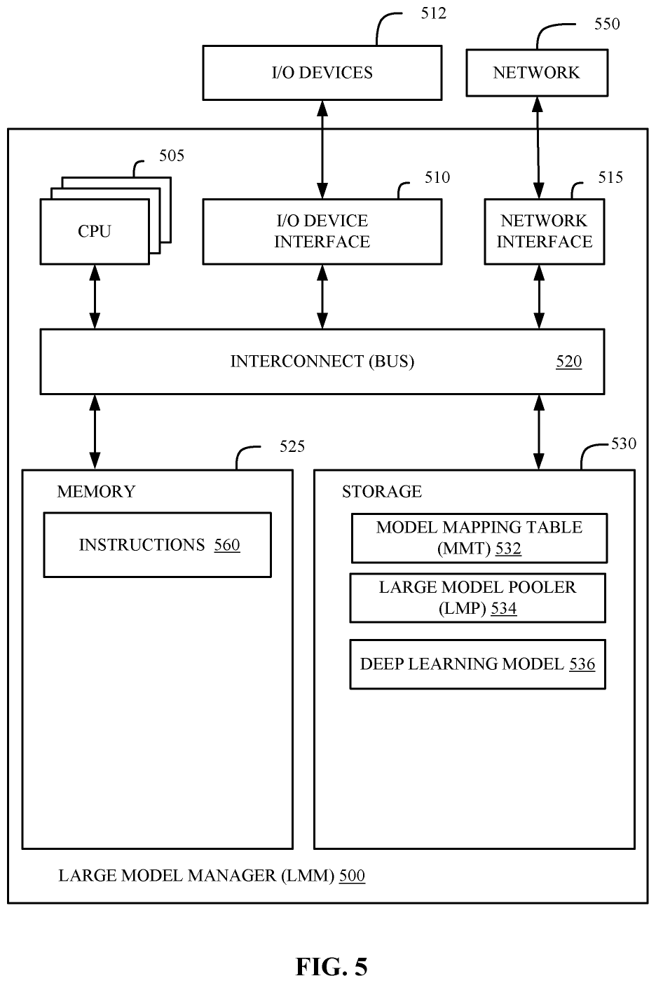

Referring now to FIG. 2, illustrated is a flowchart of an example method 200 for initializing a network architecture for deep learning, in accordance with some embodiments of the present disclosure. The method 200 can be performed by, for example, a large model manager (LMM) (e.g., LMM 102 of FIG. 1 or LMM 500 of FIG. 5). In other embodiments, the method 200 can be performed by alternative configurations of hardware and/or software. For clarity, the method 200 will be described as being performed by the LMM.

In operation 202, the LMM can create a list of host nodes (e.g., host nodes 106 of FIG. 1) for training a deep learning model. The list can be automatically created according to rules (e.g., virtually provisioned in a cloud computing environment), or manually configured (e.g., based on user input). In some embodiments, each host node contains a CPU (e.g., CPU memories 108 and CPUs 110 of FIG. 1) and/or a GPU (e.g., GPU memories 112 and GPUs 114 of FIG. 1).

In operation 204, the LMM can establish MPI communication across the list of host nodes. MPI communication can comprise MPI-1, MPI-2, MPI-3, or a different MPI protocol. In some embodiments, MPI communication comprises a one-way messaging protocol that can read from and/or write to selected portions (e.g., window regions) of different host nodes without the involvement of the other host nodes.

In operation 206, the LMM can initialize a large model pooler (LMP) by registering with a handle of a memory region (e.g., a window region) on all host nodes in the list of host nodes. In some embodiments, the LMP initialized in operation 206 is consistent with LMP 104 of FIG. 1. In some embodiments, operation 206 further comprises separating the deep learning model amongst the host nodes in the list of host nodes using the LMP (e.g., model parallelism). In various embodiments, the deep learning model can be distributed by layers, portions of layers, operations, portions of operations, or a different distribution protocol. For example, a first host node can store a first layer of the deep learning model. In another example, the first host node can store a portion of the first layer of the deep learning model and another portion of the first layer can be stored on a different host node. In other embodiments, operation 206 further comprises separating the input data amongst the host nodes in the list of host nodes using the LMP (e.g., data parallelism).

In operation 208, the LMM can generate a deep learning model mapping table (MMT). In some embodiments, the MMT generated in operation 208 can be consistent with MMT 120 of FIG. 1. The LMM can populate the MMT with information regarding the LMM, the host nodes, the LMP, and/or the deep learning model. In some embodiments, the MMT stores pointers, layer identifiers, process ranks, memory handles, memory offsets, metadata, and/or flags for respective portions of the deep learning model distributed amongst the host nodes.

FIG. 2 is intended to represent the major operations of an example method for initializing a network architecture for deep learning, according to embodiments of the present disclosure. In some embodiments, however, individual operations can have greater or lesser complexity than shown in FIG. 2, and operations other than, or in addition to those shown in FIG. 2 can be present. Furthermore, in some embodiments, various operations illustrated in FIG. 2 can have greater, lesser, or different functionality than shown in FIG. 2.

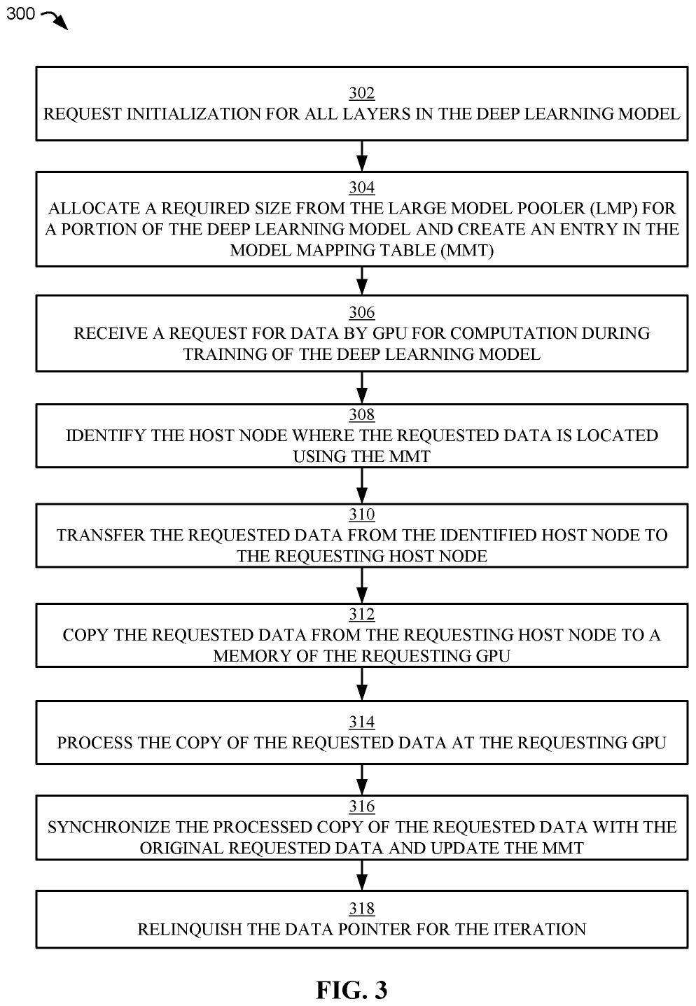

Referring now to FIG. 3, illustrated is a flowchart of an example method 300 for training a deep learning model on a distributed network architecture, in accordance with some embodiments of the present disclosure. The method 300 can be performed by, for example, a large model manager (LMM) (e.g., LMM 102 of FIG. 1 or LMM 500 of FIG. 5), or, more generally, a network architecture (e.g., network architecture 100 of FIG. 1). In other embodiments, the method 300 can be performed by alternative configurations of hardware and/or software.

In operation 302, the LMM can request initialization for all layers, parameters, and/or input data in a deep learning model. In some embodiments, operation 302 is consistent with the method 200 of FIG. 2 (or a portion thereof). A deep learning model can include an input layer, an output layer, and a plurality of hidden layers situated between the input layer and the output layer. Each layer can comprise a plurality of artificial neurons or a plurality of columns of artificial neurons.

In operation 304, the LMM can allocate the required size from the LMP (e.g., LMP 104 of FIG. 1) for respective portions of the deep learning model. The LMM can create an entry in the MMT (e.g., MMT 120 of FIG. 1) having a data pointer, a layer identifier, a rank of the process requesting the allocation, a remote memory handle, a remote memory offset, metadata, and/or flags for each respective portion of the deep learning model.

In operation 306, the LMM can receive a request for data relevant to the deep learning model by a requesting GPU (e.g., GPU 114 of FIG. 1) of a requesting host node (e.g., host 106 of FIG. 1) for forward propagation and/or backpropagation of a portion of the deep learning model.

In operation 308, the LMM can query the MMT to identify a host node where the requested data is located. The identified host node can be the requesting host node or a different host node. In some embodiments, the requested data is stored in a CPU memory (e.g., CPU memory 108 of FIG. 1) or a different memory communicatively coupled to the identified host node.

In operation 310, the LMM can transfer (e.g., copy, transmit, replicate, etc.) the requested data from the identified host node to the requesting host node (e.g., using MPI RMA) in embodiments where the requesting host node is different from the identified host node. In embodiments where the identified host node is the same as the requesting host node, operation 310 is not necessary since the requested data already resides on the appropriate host node. In some embodiments, operation 310 is consistent with transferring 118A of FIG. 1.

In operation 312, the LMM can copy the requested data from the requesting host node to the memory associated with the requesting GPU (e.g., GPU memory 112). Operation 312 can comprise creating a working copy of the requested data (e.g., copy model portion X 116C of FIG. 1). In some embodiments, operation 312 is consistent with generating and storing 118B of FIG. 1.

In operation 314, the requesting GPU can process the data. Processing data can comprise performing an operation, a portion of an operation, a function, a portion of a function, a forward propagation function, or portion thereof, and/or a backpropagation function, or portion thereof. In various embodiments, processing can be performed on multiple layers of the deep learning model, a single layer of the deep learning model, or a portion of a single layer of the deep learning model.

In operation 316, the LMM can copy updates from the LMP to the MMT in response to performing processing at the requesting GPU. In some embodiments, operation 316 further comprises synchronizing the copy of the requested data stored in the GPU memory with the original requested data that is stored either on the requesting host node or the identified host node. In some embodiments, the LMP identifies a beneficial location for the updated data to be stored in the distributed network architecture.

In operation 318, the LMM can relinquish the data pointer for the requested data of the deep learning model once the forward propagation and/or backpropagation for the requested data is complete.

Operations 306-318 can occur any number of times for any number of portions of the deep learning model until the deep learning model is fully trained. Aspects of the present disclosure advantageously allow for processing wide (e.g., large individual layers) and deep (e.g., many layers) deep learning models.

Although not explicitly shown, the method 300 can output a trained deep learning model. Outputting a trained deep learning model can comprise storing data associated with layers, parameters, gradients, biases, weights, and/or other aspects of a deep learning model. In some embodiments, outputting a trained deep learning model comprises utilizing the trained deep learning model by inputting new data into the trained learning model and receiving output data as a result of inputting the new data.

FIG. 3 is intended to represent the major operations of an example method for training a deep learning model on a network architecture, according to embodiments of the present disclosure. In some embodiments, however, individual operations can have greater or lesser complexity than shown in FIG. 3, and operations other than, or in addition to those shown in FIG. 3 can be present. Furthermore, in some embodiments, various operations illustrated in FIG. 3 can have greater, lesser, or different functionality than shown in FIG. 3.

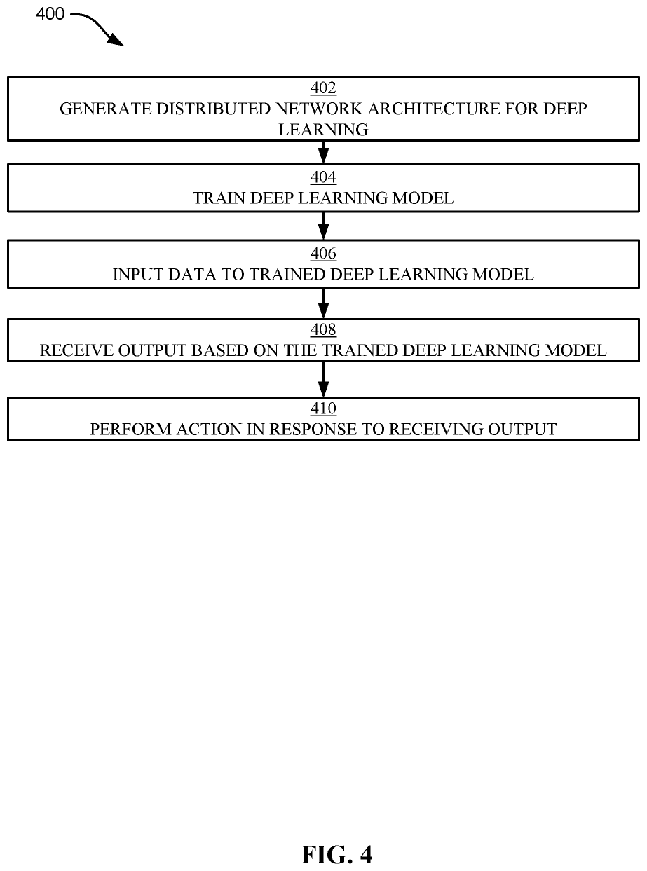

Referring now to FIG. 4, illustrated is a flowchart of an example method 400 for using a trained deep learning model, in accordance with some embodiments of the present disclosure. The method 400 can be performed by, for example, a large model manager (LMM) (e.g., LMM 102 of FIG. 1 or LMM 500 of FIG. 5). In other embodiments, the method 400 can be performed by alternative configurations of hardware and/or software. For clarity, the method 400 will be described as being performed by the LMM.

In operation 402, the LMM can generate a distributed network architecture for deep learning. In some embodiments, operation 402 is consistent with the method 200 of FIG. 2. In some embodiments, operation 402 generates a network architecture such as network architecture 100 of FIG. 1.

In operation 404, the LMM can train a deep learning model using the distributed network architecture. In some embodiments, operation 404 is consistent with the method 300 of FIG. 3.

In operation 406, the LMM can input data into the trained deep learning model. Input data can be, for instance, a medical image (e.g., x-ray, mammogram, magnetic resonance imaging (MRI) image, computed tomography (CT) scan image), other images (e.g., photographs, satellite images, etc.), a video, a set of text (e.g., a book, a speech, a conversation, an article, a DNA profile, etc.), sensor data (e.g., temperature, velocity, acceleration, composition, humidity, pressure, orientation, location, etc.), or other data. In some embodiments, the LMM can input data into the trained deep learning model in response to receiving the data from another device (e.g., computer, server, sensor, etc.) communicatively coupled to the LMM.

In operation 408, the LMM can receive output based on the input data provided to the trained deep learning model. The output can comprise, but is not limited to, one or more classifications (e.g., medical classifications, image classifications, text classifications, cybersecurity classifications, etc.), answers, notifications, or other output.

In operation 410, the LMM can perform an action in response to receiving the output from operation 408. For example, the action can comprise sending classification information to a user account (e.g., an email, a text message, a voice message, etc.), performing a mitigation action, and/or other actions.

Mitigation actions can take various forms. For example, the deep learning model can be associated with cybersecurity (e.g., operation 404). The input data can comprise log data, network data, firewall data, or other data from one or more computing devices (e.g., operation 406). The output data can be a malware notification based on the deep learning model identifying malware in the input data (e.g., operation 408). The mitigation action can comprise automatically removing the malware from the device, automatically powering down the device, and/or automatically reconfiguring (e.g., changing permission controls, isolating from a network, etc.) the device (e.g., operation 410).

As another example, the deep learning model can be associated with quality control for a manufacturing and assembly line (e.g., operation 404). The input data can be a series of measurements from a series of parts (e.g., operation 406). The output can comprise an indication that a particular machine in the manufacturing and assembly line is causing out-of-tolerance parts (e.g., operation 408). The mitigation action can comprise automatically stopping production at the identified machine producing out-of-tolerance parts, automatically changing a parameter at the identified machine (e.g., re-calibrating), sending a notification, or other mitigation actions (e.g., operation 410).

FIG. 4 is intended to represent the major operations of an example method for using a trained deep learning model, according to embodiments of the present disclosure. In some embodiments, however, individual operations can have greater or lesser complexity than shown in FIG. 4, and operations other than, or in addition to those shown in FIG. 4 can be present. Furthermore, in some embodiments, various operations illustrated in FIG. 4 can have greater, lesser, or different functionality than shown in FIG. 4.

FIG. 5 illustrates a block diagram of an example large model manager (LMM) 500 in accordance with some embodiments of the present disclosure. In various embodiments, LMM 500 performs any of the methods described in FIGS. 2-4. In some embodiments, LMM 500 provides instructions for one or more of the methods described in FIGS. 2-4 to a client machine such that the client machine executes the method, or a portion of the method, based on the instructions provided by the LMM 500.

The LMM 500 includes a memory 525, storage 530, an interconnect (e.g., BUS) 520, one or more CPUs 505 (also referred to as processors 505 herein), an I/O device interface 510, I/O devices 512, and a network interface 515.

Each CPU 505 retrieves and executes programming instructions stored in the memory 525 or storage 530. The interconnect 520 is used to move data, such as programming instructions, between the CPUs 505, I/O device interface 510, storage 530, network interface 515, and memory 525. The interconnect 520 can be implemented using one or more busses. The CPUs 505 can be a single CPU, multiple CPUs, or a single CPU having multiple processing cores in various embodiments. In some embodiments, a CPU 505 can be a digital signal processor (DSP). In some embodiments, CPU 505 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 525 is generally included to be representative of a random access memory (e.g., static random access memory (SRAM), dynamic random access memory (DRAM), or Flash). The storage 530 is generally included to be representative of a non-volatile memory, such as a hard disk drive, solid state device (SSD), removable memory cards, optical storage, or flash memory devices. In an alternative embodiment, the storage 530 can be replaced by storage area-network (SAN) devices, the cloud, or other devices connected to the LMM 500 via the I/O devices interface 510 or a network 550 via the network interface 515.

In some embodiments, the memory 525 stores instructions 560 and the storage 530 stores model mapping table (MMT) 532, large model pooler (LMP) 534, and deep learning model 536. However, in various embodiments, the instructions 560, the MMT 532, the LMP 534, and the deep learning model 536 are stored partially in memory 525 and partially in storage 530, or they are stored entirely in memory 525 or entirely in storage 530, or they are accessed over a network 550 via the network interface 515.

The MMT 532 can be consistent with MMT 120 of FIG. 1. The LMP 534 can be consistent with LMP 104 of FIG. 1. The deep learning model 536 can be any deep learning model (e.g., ANN, DNN, CNN, etc.), or portion thereof. In some embodiments the deep learning model 536 can be associated with memory requirements larger than a single GPU and/or CPU memory capacity. In some embodiments, the deep learning model 536 can contain a layer associated with a memory requirement larger than a single CPU and/or GPU memory capacity. In some embodiments, the deep learning model 536 can contain an operation associated with memory requirements larger than a single GPU and/or CPU memory capacity. In embodiments such as the aforementioned embodiments, the deep learning model 536 in the LMM 500 can comprise a portion of a deep learning model, or data regarding the deep learning model (e.g., metadata, an index, organizational data, etc.).

The instructions 560 are processor executable instructions for executing any portion of, any combination of, or all of the methods previously discussed in FIGS. 2-4. In some embodiments, instructions 560 generate a distributed network architecture consistent with the network architecture 100 of FIG. 1.

In various embodiments, the I/O devices 512 include an interface capable of presenting information and receiving input. For example, I/O devices 512 can present information to a user interacting with LMM 500 and receive input from the user.

LMM 500 is connected to the network 550 via the network interface 515. Network 550 can comprise a physical, wireless, cellular, or different network. In some embodiments, network 550 connects the LMM 500 to one or more host nodes (e.g., hosts 106 of FIG. 1), the MMT 532, the LMP 534, and/or the deep learning model 536.

FIG. 5 is intended to represent the major components of an example LMM 500 according to embodiments of the present disclosure. In some embodiments, however, individual components can have greater or lesser complexity than shown in FIG. 5, and components other than, or in addition to those shown in FIG. 5 can be present. Furthermore, in some embodiments, various components illustrated in FIG. 5 can have greater, lesser, or different functionality than shown in FIG. 5.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

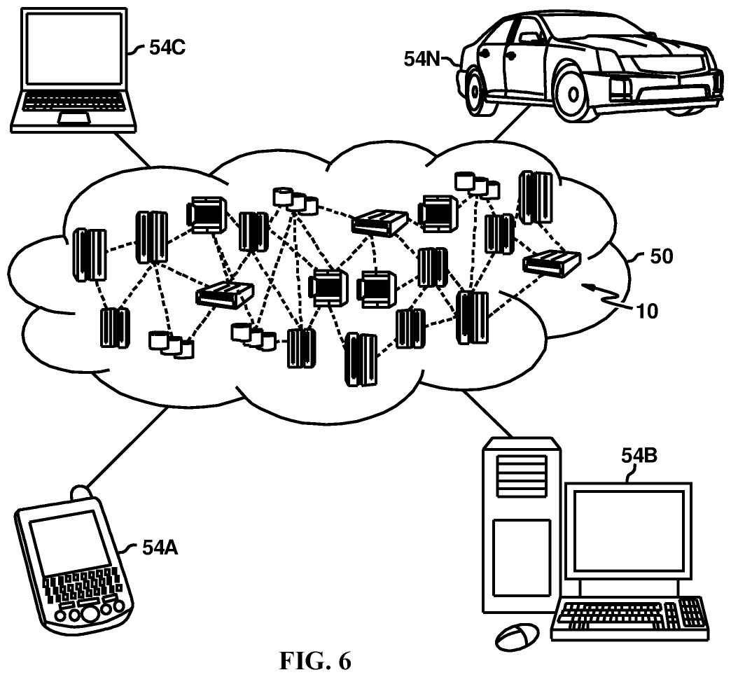

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

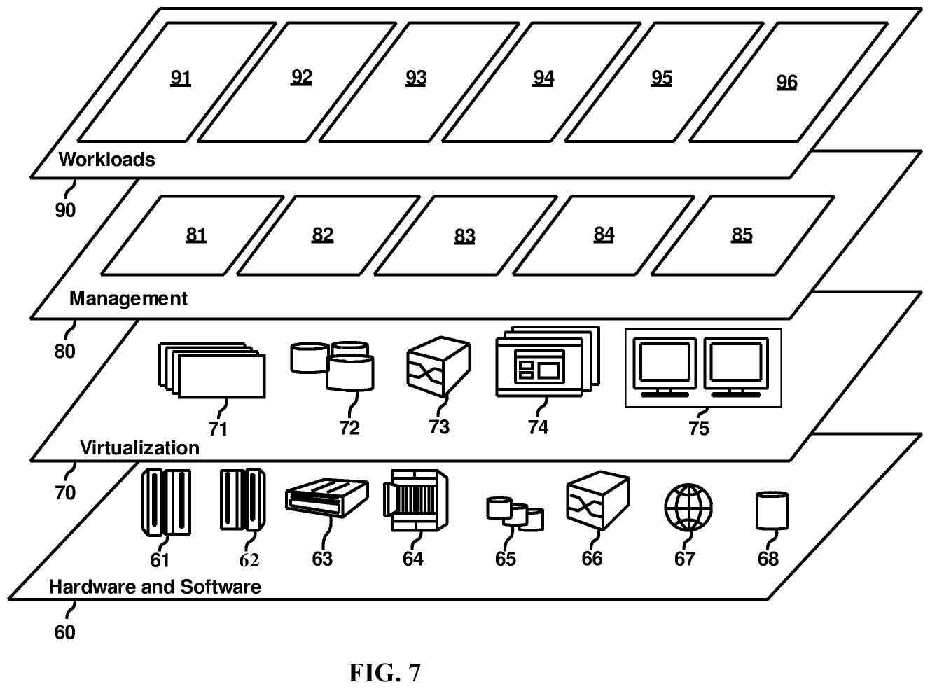

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and distributed deep learning 96.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or subset of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 560 of FIG. 5 and/or any software configured to perform any subset of the methods described with respect to FIGS. 2-4) may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

What is claimed is:

1. A computer-implemented method comprising:
generating a model mapping table (MMT) storing information regarding respective portions of a deep learning model distributed amongst a plurality of interconnected host nodes, wherein respective host nodes comprise at least one central processing unit (CPU), at least one CPU memory, at least one graphics processing unit (GPU), and at least one GPU memory, wherein the deep learning model comprises an amount of data larger than an amount of memory in any respective host node of the plurality of interconnected host nodes; and
training the deep learning model by training the respective portions of the deep learning model on the plurality of interconnected host nodes, the training comprising:
receiving a request from a requesting GPU for a first portion of the deep learning model, wherein the requesting GPU is associated with a requesting GPU memory and a requesting host node;
identifying a first host node of the plurality of interconnected host nodes storing the first portion of the deep learning model based on information in the MMT;
transferring the first portion of the deep learning model from the first host node to the requesting host node;
providing a first copy of the first portion of the deep learning model from the requesting host node to the requesting GPU memory;
performing processing, by the requesting GPU, on the first copy of the first portion of the deep learning model stored in the requesting GPU memory;
synchronizing the first copy of the first portion of the deep learning model with the first portion of the deep learning model in response to performing processing; and
updating the MMT based on synchronizing the first copy of the first portion of the deep learning model.

2. The method of claim 1, wherein transferring the first portion of the deep learning model comprises using a message passing interface (MPI) remote memory access (RMA) protocol.

3. The method of claim 1, wherein the MMT comprises a first entry associated with the first portion of the deep learning model, wherein the first entry comprises a first pointer, a first layer identifier, a first memory handle, a first memory offset, and a first process rank.

4. The method according to claim 3, wherein the first pointer points to a location of the first portion of the deep learning model in the plurality of interconnected host nodes;
wherein the first layer identifier indicates a layer of the deep learning model associated with the first portion of the deep learning model;
wherein the first memory handle indicates a location of a window associated with the first portion of the deep learning model in the first host node;
wherein the first memory offset indicates a location of the first portion of the deep learning model in the window of the first host node; and
wherein the first process rank comprises a rank of a process associated with the requesting GPU.

5. The method of claim 4, wherein the first entry is further associated with metadata indicating a data type of the first portion of the deep learning model.

6. The method according to claim 5, wherein the first entry is further associated with a flag indicating a first function that is associated with the first portion of the deep learning model, wherein the first function is selected from the group consisting of: a reuse data function, and a recompute function.

7. The method according to claim 1, wherein performing processing on the first copy of the first portion of the deep learning model comprises performing forward propagation for a portion of a layer of the deep learning model.

8. The method according to claim 1, wherein the first portion of the deep learning model comprises a portion of a first operation for training the deep learning model, wherein the first operation is associated with a first amount of data that is larger than a memory capacity of the first host node.

9. A system comprising:
a processor; and
a computer-readable storage medium storing program instructions for deep learning model training which, when executed by the processor, are configured to cause the processor to perform a method comprising:
generating a model mapping table (MMT) storing information regarding respective portions of a deep learning model distributed amongst a plurality of interconnected host nodes, wherein respective host nodes comprise at least one central processing unit (CPU), at least one CPU memory, at least one graphics processing unit (GPU), and at least one GPU memory, wherein the deep learning model comprises an amount of data larger than an amount of memory in any respective host node of the plurality of interconnected host nodes; and
training the deep learning model by training the respective portions of the deep learning model on the plurality of interconnected host nodes, the training comprising:
receiving a request from a requesting GPU for a first portion of the deep learning model, wherein the requesting GPU is associated with a requesting GPU memory and a requesting host node;
identifying a first host node of the plurality of interconnected host nodes storing the first portion of the deep learning model based on information in the MMT;
transferring the first portion of the deep learning model from the first host node to the requesting host node;
providing a first copy of the first portion of the deep learning model from the requesting host node to the requesting GPU memory;
performing processing, by the requesting GPU, on the first copy of the first portion of the deep learning model stored in the requesting GPU memory;
synchronizing the first copy of the first portion of the deep learning model with the first portion of the deep learning model in response to performing processing; and
updating the MMT based on synchronizing the first copy of the first portion of the deep learning model.

10. The system according to claim 9, wherein the program instructions were downloaded over a network from a remote data processing system.

11. The system according to claim 9, wherein the program instructions are stored in a computer-readable storage medium in a server data processing system, and wherein the instructions were downloaded over a network to the system to provide deep learning model training functionality to the system.

12. The system according to claim 11, wherein the program instructions are configured to cause the processor to perform a method further comprising:
metering use of the deep learning model training functionality in the system; and
generating an invoice in response to metering use of the deep learning model training functionality.

13. The system according to claim 9, wherein transferring the first portion of the deep learning model comprises using a message passing interface (MPI) remote memory access (RMA) protocol.

14. The system according to claim 9, wherein the MMT comprises a first entry associated with the first portion of the deep learning model, wherein the first entry comprises a first pointer, a first layer identifier, a first memory handle, a first memory offset, and a first process rank.

15. A computer program product comprising a computer readable storage medium, wherein the computer readable storage medium does not comprise a transitory signal per se, wherein the computer readable storage medium stores instructions executable by a processor to cause the processor to perform a method comprising:
generating a model mapping table (MMT) storing information regarding respective portions of a deep learning model distributed amongst a plurality of interconnected host nodes, wherein respective host nodes comprise at least one central processing unit (CPU), at least one CPU memory, at least one graphics processing unit (GPU), and at least one GPU memory, wherein the deep learning model comprises an amount of data larger than an amount of memory in any respective host node of the plurality of interconnected host nodes; and
outputting a trained deep learning model by training the respective portions of the deep learning model on the plurality of interconnected host nodes, wherein training respective portions of the deep learning model comprises transferring, using a message passing interface (MPI) remote memory access (RMA) protocol, respective portions of the deep learning model between respective host nodes of the plurality of interconnected host nodes and providing respective copies of the respective portions of the deep learning model to respective GPU memories for processing by respective GPUs.

16. The computer program product according to claim 15, wherein training the respective portions of the deep learning model further comprises:
receiving a request from a requesting GPU for a first portion of the deep learning model, wherein the requesting GPU is associated with a requesting GPU memory and a requesting host node;
identifying a first host node of the plurality of interconnected host nodes storing the first portion of the deep learning model based on information in the MMT;
transferring the first portion of the deep learning model from the first host node to the requesting host node;
providing a first copy of the first portion of the deep learning model from the requesting host node to the requesting GPU memory;
performing processing, by the requesting GPU, on the first copy of the first portion of the deep learning model stored in the requesting GPU memory;
synchronizing the first copy of the first portion of the deep learning model with the first portion of the deep learning model in response to performing processing; and
updating the MMT based on synchronizing the first copy of the first portion of the deep learning model.

17. The computer program product according to claim 16, wherein the MMT comprises a first entry associated with the first portion of the deep learning model, wherein the first entry comprises a first pointer, a first layer identifier, a first memory handle, a first memory offset, and a first process rank.

18. The computer program product according to claim 17, wherein the first pointer points to a location of the first portion of the deep learning model in the plurality of interconnected host nodes;
wherein the first layer identifier indicates a layer of the deep learning model associated with the first portion of the deep learning model;
wherein the first memory handle indicates a location of a window associated with the first portion of the deep learning model in the first host node;
wherein the first memory offset indicates a location of the first portion of the deep learning model in the window of the first host node;
wherein the first process rank comprises a rank of a process associated with the requesting GPU.

19. The computer program product according to claim 18, wherein performing processing on the first copy of the first portion of the deep learning model comprises performing forward propagation for a portion of a layer of the deep learning model.

20. The computer program product according to claim 18, wherein performing processing on the first copy of the first portion of the deep learning model comprises performing backpropagation for a portion of a layer of the deep learning model.
